(19) United States
(12) Patent Application Publication
(10) Pub. No.: US 2025/0216881 A1
(43) Pub. Date: Jul. 3, 2025

(54) LINEAR REGULATOR AND ELECTRONIC DEVICE INCLUDING THE SAME

(71) Applicant: Samsung Electronics Co., Ltd., Suwon-si (KR)

(72) Inventors: Hoyoung Shin, Suwon-si (KR); Jaeyun Park, Suwon-si (KR); Hyunwook Song, Suwon-si (KR); Changseob Shin, Suwon-si (KR)

(21) Appl. No.: 18/964,283

(22) Filed: Nov. 29, 2024

(30) Foreign Application Priority Data
Dec. 27, 2023 (KR) 10-2023-0192114
Jun. 10, 2024 (KR) 10-2024-0074935

(51) Int. Cl. G05F 1/575

(52) U.S. Cl. CPC G05F 1/575

(57) ABSTRACT

A linear regulator includes a compensation circuit, an adaptive gain control circuit, a buffer circuit, a driver circuit and a feedback circuit. The compensation circuit generates a compensation voltage based on a feedback voltage. A voltage level of the compensation voltage is changed based on a load current that is generated by an output voltage and flows through an output terminal. The adaptive gain control circuit tracks the load current based on the compensation voltage, and generates a first driving voltage by adjusting a loop gain based on an amount of the load current. The buffer circuit generates a second driving voltage by buffering the first driving voltage. The driver circuit is connected to the output terminal, and generates the output voltage based on the second driving voltage. The feedback circuit is connected to the output terminal, and generates the feedback voltage based on the output voltage.

### CROSS-REFERENCE TO RELATED APPLICATION(S)

This application claims priority under 35 USC § 119 to Korean Patent Application Nos. 10-2023-0192114 filed on Dec. 27, 2023 and 10-2024-0074935 filed on Jun. 10, 2024 in the Korean Intellectual Property Office (KIPO), the disclosure of each of which is herein incorporated by reference in its entirety.

### BACKGROUND

### 1. Technical Field

Example embodiments relate generally to semiconductor integrated circuits, and more particularly to linear regulators, and electronic devices including the linear regulators.

### 2. Description of the Related Art

Generally, power supply devices are needed to supply voltages for operations of electronic circuits and/or systems. For example, a power supply device may include a switching regulator having relatively high efficiency or a linear regulator having relatively high performance. Recently, as the demand for linear regulators with high-capacity increases, the range of load current covered by linear regulators is increasing.

### SUMMARY

At least one example embodiment of the present disclosure provides a linear regulator capable of achieving high loop stability and high transient response.

At least one example embodiment of the present disclosure provides an electronic device including the linear regulator.

According to example embodiments, a linear regulator includes a compensation circuit, an adaptive gain control circuit, a buffer circuit, a driver circuit and a feedback circuit. The compensation circuit generates a compensation voltage based on a reference voltage and a feedback voltage. A voltage level of the compensation voltage is changed based on a load current that is generated by an output voltage and flows through an output terminal. The adaptive gain control circuit tracks the load current based on the compensation voltage, and generates a first driving voltage by adjusting a loop gain based on an amount of the load current. The buffer circuit generates a second driving voltage by buffering the first driving voltage. The driver circuit is connected to the output terminal, and generates the output voltage based on the second driving voltage. The feedback circuit is connected to the output terminal, and generates the feedback voltage based on the output voltage.

According to example embodiments, an electronic device includes a first semiconductor chip, an output capacitor and a second semiconductor chip. The first semiconductor chip includes a linear regulator that provides an output voltage through an output terminal. The output capacitor is connected between the output terminal and a ground voltage. The second semiconductor chip receives the output voltage as a power supply voltage. The linear regulator includes a compensation circuit, an adaptive gain control circuit, a buffer circuit, a driver circuit and a feedback circuit. The compensation circuit generates a compensation voltage based on a reference voltage and a feedback voltage. A voltage level of the compensation voltage is changed based on a load current that is generated by the output voltage and flows through the output terminal. The adaptive gain control circuit tracks the load current based on the compensation voltage, and generates a first driving voltage by adjusting a loop gain based on an amount of the load current. The buffer circuit generates a second driving voltage by buffering the first driving voltage. The driver circuit is connected to the output terminal, and generates the output voltage based on the second driving voltage. The feedback circuit is connected to the output terminal, and generates the feedback voltage based on the output voltage.

According to example embodiments, a linear regulator includes a compensation circuit, an adaptive gain control circuit, a buffer circuit, a driver circuit and a feedback circuit. The compensation circuit generates a compensation voltage based on a reference voltage and a feedback voltage. A voltage level of the compensation voltage is changed based on a load current that is generated by an output voltage and flows through an output terminal. The adaptive gain control circuit tracks the load current based on the compensation voltage, and generates a first driving voltage by adjusting a loop gain based on an amount of the load current. The buffer circuit generates a second driving voltage by buffering the first driving voltage. The driver circuit is connected to the output terminal, and generates the output voltage based on the second driving voltage. The feedback circuit is connected to the output terminal, and generates the feedback voltage based on the output voltage. The adaptive gain control circuit includes a current source, a first transistor, a second transistor, a third transistor, a fourth transistor and a fifth transistor. The current source is connected between an input voltage and a first node. The first transistor is connected between the first node and a ground voltage, and has a gate electrode connected to the first node. The second transistor is connected to a second node receiving the compensation voltage, and has a gate electrode connected to the first node. The third transistor is connected between the second transistor and the ground voltage, and has a gate electrode connected to the second node. The fourth transistor is fourth transistor connected between the second node and the ground voltage, and has a gate electrode connected to the second node. The fifth transistor is connected between the ground voltage and a third node providing the first driving voltage, and has a gate electrode connected to the second node. When the amount of the load current increases, the loop gain increases and the loop gain is determined based on a gain of the fourth transistor. When the amount of the load current decreases, the loop gain decreases and the loop gain is determined based on a gain of the second transistor and a gain of the third transistor.

In the linear regulator and the electronic device according to example embodiments, the adaptive gain control circuit may be implemented for tracking the load current and adaptively and/or dynamically adjusting the loop gain depending on the amount of the load current. In a heavy load condition where the amount of the load current increases, the loop gain may increase (e.g., boost) to improve the gain bandwidth and the transient response. In a light load condition where the amount of the load current decreases, the loop gain may decrease to ensure the loop stability. Accordingly, a relatively high loop stability and a relatively high transient response may be achieved or obtained over the entire range of the load current without changing the position of the dominant pole, and the performance of the linear regulator may be improved or enhanced.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a linear regulator according to example embodiments.

FIG. 2 is a circuit diagram illustrating a linear regulator according to example embodiments.

FIGS. 3A, 3B, 4, 5A and 5B are diagrams for describing an operation of a linear regulator of FIG. 2 according to example embodiments.

FIG. 6 is a circuit diagram illustrating a linear regulator according to example embodiments.

FIGS. 7A and 7B are diagrams for describing an operation of a linear regulator of FIG. 6 according to example embodiments.

FIG. 8 is a block diagram illustrating a linear regulator according to example embodiments.

FIG. 9 is a flowchart illustrating a method of generating an output voltage according to example embodiments.

FIG. 10 is a flowchart illustrating an example of generating a first driving voltage in FIG. 9 according to example embodiments.

FIG. 11 is a block diagram illustrating an electronic device including a linear regulator according to example embodiments.

FIG. 12 is a block diagram illustrating an electronic system according to example embodiments.

### DETAILED DESCRIPTION OF THE EMBODIMENTS

Various example embodiments will be described more fully with reference to the accompanying drawings, in which embodiments are shown. The present disclosure may, however, be embodied in many different forms and should not be construed as limited to the embodiments set forth herein. Like reference numerals refer to like elements throughout this application.

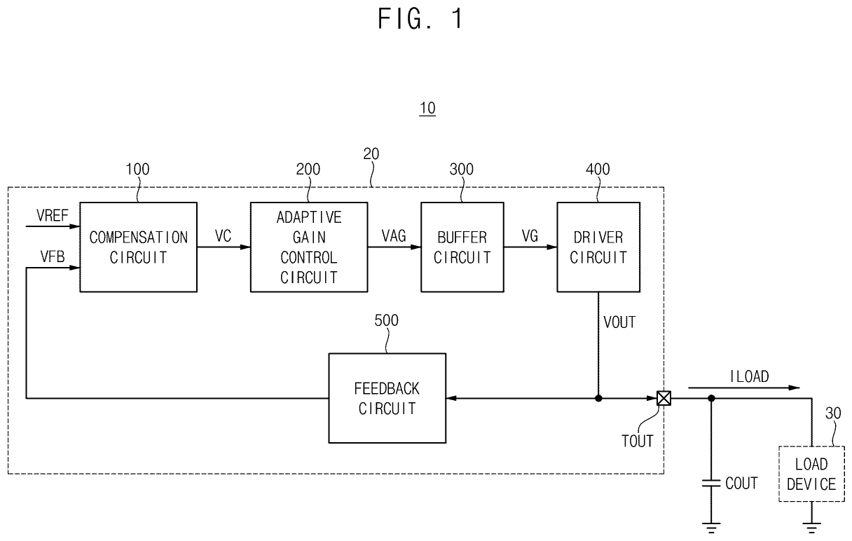

FIG. 1 is a block diagram illustrating a linear regulator according to example embodiments.

Referring to FIG. 1, a linear regulator 10 includes a compensation circuit (or compensator) 100, an adaptive gain control circuit (or adaptive gain controller) 200, a buffer circuit (or buffer) 300, a driver circuit (or driver) 400, a feedback circuit (or feedback unit) 500 and an output terminal TOUT.

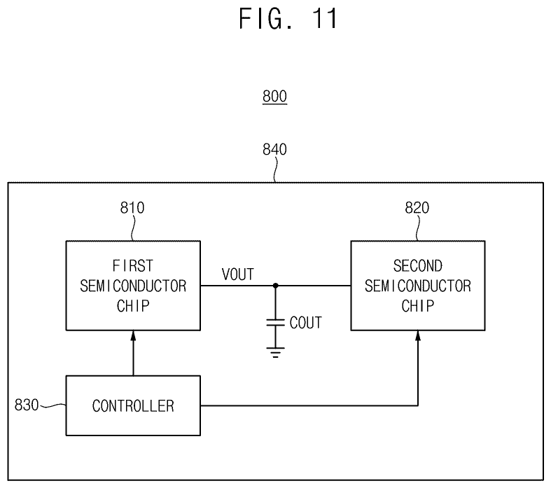

In some example embodiments, components (e.g., the compensation circuit 100, the adaptive gain control circuit 200, the buffer circuit 300, the driver circuit 400, the feedback circuit 500 and the output terminal TOUT) included in the linear regulator 10 may be included in a semiconductor chip 20, and may be electrically connected to an output capacitor COUT and a load device 30 that are located outside the semiconductor chip 20. For example, the semiconductor chip 20, the output capacitor COUT and the load device 30 may be included in an electronic device and/or an electronic system, and may be mounted on a printed circuit board (PCB). An electronic device including the linear regulator 10 will be described with reference to FIG. 11.

The linear regulator 10 may generate an output voltage VOUT, may provide (or output) the output voltage VOUT through the output terminal TOUT, and may supply a load current ILOAD to the load device 30 based on the output voltage VOUT. The output voltage VOUT may be supplied as a power supply voltage to the load device 30, and the load device 30 may consume the load current ILOAD based on the output voltage VOUT.

The compensation circuit 100 generates a compensation voltage VC based on a reference voltage VREF and a feedback voltage VFB. A voltage level of the compensation voltage VC is changed based on the load current ILOAD. As described above, the load current ILOAD may represent a current that is generated by the output voltage VOUT, flows through the output terminal TOUT and is supplied to the load device 30, and is consumed by the load device 30. In some example embodiments, the reference voltage VREF may be provided from the inside or outside of the linear regulator 10, e.g., externally or internally of the semiconductor chip 20. The feedback voltage VFB may be generated based on the output voltage VOUT, and may be generated by the feedback circuit 500.

The adaptive gain control circuit 200 tracks the load current ILOAD based on the compensation voltage VC, and generates a first driving voltage VAG by adjusting a loop gain based on the amount of the load current ILOAD. For example, when the amount of the load current ILOAD increases, the loop gain may increase. For example, when the amount of the load current ILOAD decreases, the loop gain may decrease. For example, the adaptive gain control circuit 200 may perform a self-gain control function. The loop gain may be referred to as a buffer gain.

The buffer circuit 300 generates a second driving voltage VG by buffering the first driving voltage VAG. The driver circuit 400 is connected to the output terminal TOUT, and generates the output voltage VOUT based on the second driving voltage VG. The feedback circuit 500 is connected to the output terminal TOUT, and generates the feedback voltage VFB based on the output voltage VOUT.

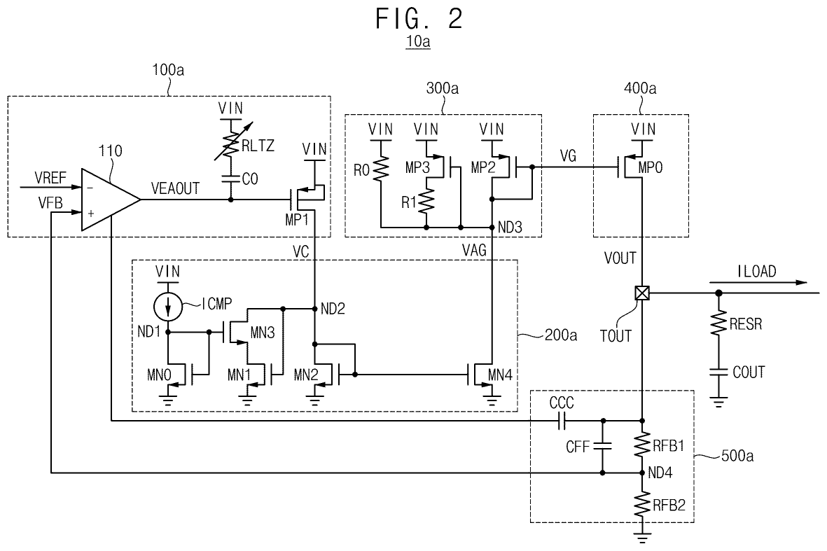

Although not illustrated in FIG. 1, the linear regulator 10 (e.g., the semiconductor chip 20) may further include an input terminal receiving an input voltage (e.g., an input voltage VIN in FIG. 2). Some components (e.g., the compensation circuit 100, the adaptive gain control circuit 200, the buffer circuit 300 and the driver circuit 400) included in the linear regulator 10 may operate based on the input voltage, and the linear regulator 10 may generate the output voltage VOUT based on the input voltage. The input voltage may be referred to as a power supply voltage or an input power supply voltage of the linear regulator 10.

The output capacitor COUT may be connected between the output terminal TOUT and a ground voltage (or a ground terminal receiving the ground voltage). In FIG. 1 and subsequent figures, three parallel straight lines with different lengths connected to the output capacitor COUT may represent the ground voltage. The output capacitor COUT may be located outside the linear regulator 10, e.g., outside the semiconductor chip 20, and may be referred to as an external capacitor.

In some example embodiments, the linear regulator 10 may be or may include a low dropout (LDO) regulator. However, the present invention is not limited thereto.

An example of a circuit configuration of the linear regulator 10 will be described with reference to FIG. 2.

The range of the load current covered by a linear regulator is increasing. To supply a large amount of the load current, a linear regulator connected to an external capacitor has been used. However, there were problems in that the output pole frequency may vary significantly depending on the load current, the position of the dominant pole may be changed, and it may be difficult to maintain the high transient response while satisfying the high loop stability over the entire range of the load current.

In the linear regulator 10 according to example embodiments, the adaptive gain control circuit 200 may be implemented for tracking the load current ILOAD and adaptively and/or dynamically adjusting the loop gain depending on the amount of the load current ILOAD. According to example embodiments, in a heavy load condition where the amount of the load current ILOAD increases, the loop gain may increase (e.g., boost) to improve the gain bandwidth and the transient response, and in a light load condition where the amount of the load current ILOAD decreases, the loop gain may decrease to ensure the loop stability. Accordingly, a relatively high loop stability and a relatively high transient response may be achieved or obtained over the entire range of the load current ILOAD without changing the position of the dominant pole, and the performance of the linear regulator 10 may be improved or enhanced.

FIG. 2 is a circuit diagram illustrating a linear regulator according to example embodiments.

Referring to FIG. 2, a linear regulator 10a may include a compensation circuit 100a, an adaptive gain control circuit 200a, a buffer circuit 300a, a driver circuit 400a, a feedback circuit 500a and the output terminal TOUT. The compensation circuit 100a, the adaptive gain control circuit 200a, the buffer circuit 300a, the driver circuit 400a, the feedback circuit 500a and the output terminal TOUT of the linear regulator 10a may respectively correspond to the compensation circuit 100, the adaptive gain control circuit 200, the buffer circuit 300, the driver circuit 400, the feedback circuit 500 and the output terminal TOUT of the linear regulator 10 of FIG. 1. For convenience of illustration, a component corresponding to the load device 30 in FIG. 1 is omitted. The descriptions repeated with or overlapping with descriptions of FIG. 1 will be omitted in the interest of brevity.

The adaptive gain control circuit 200a may include a current source ICMP, a first transistor MN0, a second transistor MN3, a third transistor MN1, a fourth transistor MN2 and a fifth transistor MN4.

The current source ICMP may be connected between the input voltage VIN (or the input terminal receiving the input voltage VIN) and a first node ND1. The current source ICMP may operate as a current clamping circuit.

The first transistor MN0 may include a first electrode (e.g., a drain electrode) connected to the first node ND1, a second electrode (e.g., a source electrode) connected to the ground voltage, and a gate electrode connected to the first node ND1. In other words, the first transistor MN0 may be connected between the first node ND1 and the ground voltage, and the gate electrode of the first transistor MN0 may be connected to the first node ND1.

The second transistor MN3 may include a first electrode connected to a second node ND2 receiving the compensation voltage VC, a second electrode connected to the third transistor MN1, and a gate electrode connected to the first node ND1. In other words, the second transistor MN3 may be connected between the second node ND2 and the third transistor MN1, and the gate electrode of the second transistor MN3 may be connected to the first node ND1.

The third transistor MN1 may include a first electrode connected to the second transistor MN3, a second electrode connected to the ground voltage, and a gate electrode connected to the second node ND2. In other words, the third transistor MN1 may be connected between the second transistor MN3 and the ground voltage, and the gate electrode of the third transistor MN1 may be connected to the second node ND2.

The fourth transistor MN2 may include a first electrode connected to the second node ND2, a second electrode connected to the ground voltage, and a gate electrode connected to the second node ND2. In other words, the fourth transistor MN2 may be connected between the second node ND2 and the ground voltage, and the gate electrode of the fourth transistor MN2 may be connected to the second node ND2.

A circuit including the second and third transistors MN3 and MN1 and a circuit including the fourth transistor MN2 may be connected in parallel between the second node ND2 and the ground voltage.

The fifth transistor MN4 may include a first electrode connected to a third node ND3 providing the first driving voltage VAG, a second electrode connected to the ground voltage, and a gate electrode connected to the second node ND2. In other words, the fifth transistor MN4 may be connected between the third node ND3 and the ground voltage, and the gate electrode of the fifth transistor MN4 may be connected to the second node ND2.

In some example embodiments, each of the first transistor MN0, the second transistor MN3, the third transistor MN1, the fourth transistor MN2 and the fifth transistor MN4 may be an n-type metal oxide semiconductor (NMOS) transistor. However, the present invention is not limited thereto.

As described above, the adaptive gain control circuit 200a may be implemented in the form of a two-stage amplifier. For example, the adaptive gain control circuit 200a may be implemented as a current amplifier with a current clamp circuit added to a second stage so that the gain may be changed depending on the amount of the load current ILOAD.

The compensation circuit 100a may include a comparator 110, a first resistor RLTZ, a first capacitor C0 and a sixth transistor MP1.

The comparator 110 may generate a first voltage VEAOUT based on the reference voltage VREF and the feedback voltage VFB. For example, the comparator 110 may include a first input terminal receiving the reference voltage VREF, a second input terminal receiving the feedback voltage VFB, and an output terminal outputting the first voltage VEAOUT.

The first resistor RLTZ and the first capacitor C0 may be connected in series between the input voltage VIN and the output terminal of the comparator 110. For example, as illustrated in FIG. 2, the first resistor RLTZ may be a variable resistor.

The sixth transistor MP1 may include a first electrode (e.g., a source electrode) connected to the input voltage VIN, a second electrode (e.g., a drain electrode) connected to the second node ND2, and a gate electrode receiving the first voltage VEAOUT. For example, the sixth transistor MP1 may be connected between the input voltage VIN and the second node ND2, and the gate electrode of the sixth transistor MP1 may receive the first voltage VEAOUT. In addition, the input voltage VIN may be provided as a body bias voltage of the sixth transistor MP1.

In some example embodiments, the sixth transistor MP1 may be a p-type metal oxide semiconductor (PMOS) transistor. However, the present invention is not limited thereto.

In some example embodiments, a voltage level of the first voltage VEAOUT may vary or may be changed depending on the amount of the load current ILOAD, and the voltage level of the compensation voltage VC may vary or may be changed as the voltage level of the first voltage VEAOUT varies. For example, when the amount of the load current ILOAD increases, a voltage level of the feedback voltage VFB and the voltage level of the first voltage VEAOUT may decrease and the voltage level of the compensation voltage VC may increase. For example, when the amount of the load current ILOAD decreases, the voltage levels of the feedback voltage VFB and the first voltage VEAOUT may increase and the voltage level of the compensation voltage VC may decrease.

The buffer circuit 300a may include a second resistor R0, a third resistor R1, a seventh transistor MP3 and an eighth transistor MP2.

The second resistor R0 may be connected between the input voltage VIN and the third node ND3. The third resistor R1 may be connected between the seventh transistor MP3 and the third node ND3.

The seventh transistor MP3 may include a first electrode connected to the input voltage VIN, a second electrode connected to the third resistor R1, and a gate electrode connected to the third node ND3. In other words, the seventh transistor MP3 may be connected between the input voltage VIN and the third resistor R1, and the gate electrode of the seventh transistor MP3 may be connected to the third node ND3.

The eighth transistor MP2 may include a first electrode connected to the input voltage VIN, a second electrode connected to the third node ND3, and a gate electrode connected to the third node ND3. For example, the eighth transistor MP2 may be connected between the input voltage VIN and the third node ND3, and the gate electrode of the eighth transistor MP2 may be connected to the third node ND3. For example, a voltage on the third node ND3 may be the first driving voltage VAG and the second driving voltage VG.

A circuit including the second resistor R0, a circuit including the seventh transistor MP3 and the third resistor R1, and a circuit including the eighth transistor MP2 may be connected in parallel between the input voltage VIN and the third node ND3.

The driver circuit 400a may include a ninth transistor MP0. The ninth transistor MP0 may include a first electrode connected to the input voltage VIN, a second electrode connected to the output terminal TOUT, and a gate electrode connected to the third node ND3. In other words, the ninth transistor MP0 may be connected between the input voltage VIN and the output terminal TOUT, and the gate electrode of the ninth transistor MP0 may be connected to the third node ND3.

In some example embodiments, each of the seventh transistor MP3, the eighth transistor MP2 and the ninth transistor MP0 may be a PMOS transistor. However, the present invention is not limited thereto.

The feedback circuit 500a may include a first feedback resistor RFB1 and a second feedback resistor RFB2, and may further include capacitors CCC and CFF.

The first feedback resistor RFB1 may be connected between the output terminal TOUT and a fourth node ND4 providing the feedback voltage VFB. The second feedback resistor RFB2 may be connected between the fourth node ND3 and the ground voltage. The second feedback resistor RFB2 may be connected between the fourth node ND4 and the ground voltage. The capacitor CCC may be connected between the output terminal TOUT and the comparator 110. The capacitor CFF may be connected in parallel with the first feedback resistor RFB1 between the output terminal TOUT and the fourth node ND4.

The output capacitor COUT may be modeled to include a resistor RESR connected in series with the output capacitor COUT. The resistor RESR may be a modeling element of an equivalent series resistor (ESR) inside a dielectric constituting the output capacitor COUT. The resistor RESR may not be included in a real product (e.g., the resistor RESR may be a parasitic component). Hereinafter, the resistor RESR will be described as not exist when describing a physical connection of the output capacitor COUT.

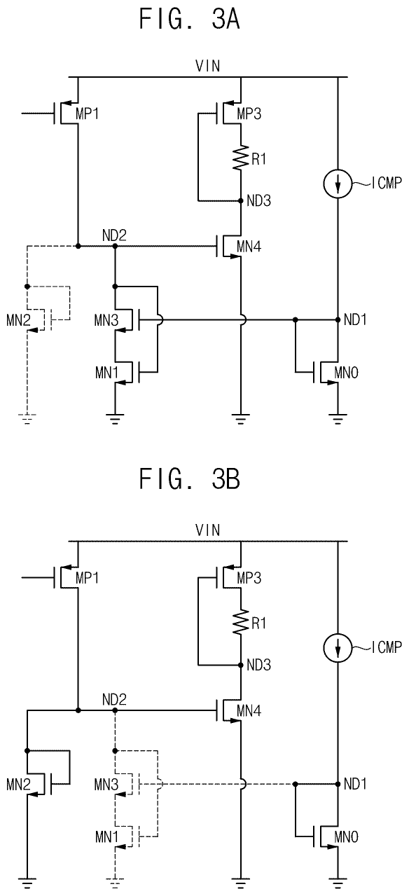

FIGS. 3A, 3B, 4, 5A and 5B are diagrams for describing an operation of a linear regulator of FIG. 2 according to example embodiments.

Referring to FIGS. 3A and 3B, equivalent circuits of the current source ICMP, the transistors MP1, MP3, MN0, MN1, MN2, MN3 and MN4 and the resistor R1 included in the linear regulator 10a of FIG. 2 are illustrated. FIG. 3A illustrates an operation under the light load condition where the amount of the load current ILOAD is relatively small. FIG. 3B illustrates an operation under the heavy load condition where the amount of the load current ILOAD is relatively large.

As illustrated in FIG. 3A, when the amount of the load current ILOAD is relatively small, the second and third transistors MN3 and MN1 may be activated (e.g., enabled or turned on), the fourth transistor MN2 may be relatively small activated or may be deactivated (e.g., disabled or turned off), and the loop gain may be determined based on a gain of the second transistor MN3 and a gain of the third transistor MN1. The second and third transistors MN3 and MN1 may be referred to as a first loop gain determination circuit, a loop gain determination circuit for the light load, etc.

As illustrated in FIG. 3B, when the amount of the load current ILOAD is relatively large, the fourth transistor MN2 may be activated (e.g., enabled or turned on), the second and third transistors MN3 and MN1 may be relatively small activated or may be deactivated (e.g., disabled or turned off), and the loop gain may be determined based on a gain of the fourth transistor MN2. The fourth transistor MN2 may be referred to as a second loop gain determination circuit, a loop gain determination circuit for the heavy load, etc.

In some example embodiments, the loop gain may be obtained based on Equation 1.

$$GA = gmp 1 ⋆ Rout ⋆ ( gmn 2 / gmn 1 ) \qquad [ Equation 1 ]$$

In Equation 1, “GA” denotes the loop gain, “gmp1” denotes a gain of the sixth transistor MP1, which is a PMOS transistor, “Rout” denotes a resistance of the third resistor R1, “gmn2” denotes a gain of the fifth transistor MN4, which is an NMOS transistor, and “gmn1” denotes a gain of an NMOS transistor (e.g., the gain of the first loop gain determination circuit or the gain of the second loop gain determination circuit), which is activated depending on the amount of the load current ILOAD. Since “gmp1”, “Rout” and “gmn2” are fixed, the loop gain may be changed and/or adjusted depending on the change in “gmn1” caused by the amount of the load current ILOAD.

In some example embodiments, the gain of the fourth transistor MN2 may be smaller than the gain of the second transistor MN3 and the gain of the third transistor MN1. For example, the gain of the fourth transistor MN2 may be about 2, the gain of the second transistor MN3 may be about 8, and the gain of the third transistor MN1 may be about 16. For example, the gain of the fifth transistor MN4 may be about 128, which is greater than the gains of the remaining NMOS transistors.

In an example where the gains of the transistors MN1, MN2, MN3 and MN4 are implemented as described above, the loop gain may increase when the amount of the load current ILOAD increases, and the loop gain may decrease when the amount of the load current ILOAD decreases.

Under the light load condition in FIG. 3A, the gain of the third transistor MN1 may mainly affect while determining the loop gain, and the loop gain may have a relatively small value. For example, it may be approximated as GA_{light}=gmp1*Rout*(128/16).

As compared with FIG. 3A, under the heavy load condition in FIG. 3B, the amount of a current required for the fifth transistor MN4 may increase when the amount of the load current ILOAD increases. In this case, the voltage level of each of the feedback voltage VFB and the first voltage VEAOUT may decrease and the voltage level of each of the first drive voltage VAG and the second driving voltage VG may decrease. In addition, a current flowing through the third transistor MN1 may be clamped by the second transistor MN3. For example, under the heavy load condition in FIG. 3B, the gain of the fourth transistor MN2 may mainly affect while determining the loop gain, and the loop gain may have a relatively large value. For example, it may be approximated as GA_{heavy}=gmp1*Rout*(128/2).

As described above, the loop gain may be controlled by adding a current clamping for each current branch and by adjusting a mirror ratio, and the loop gain control function depending on the load current ILOAD may be implemented in multi-point.

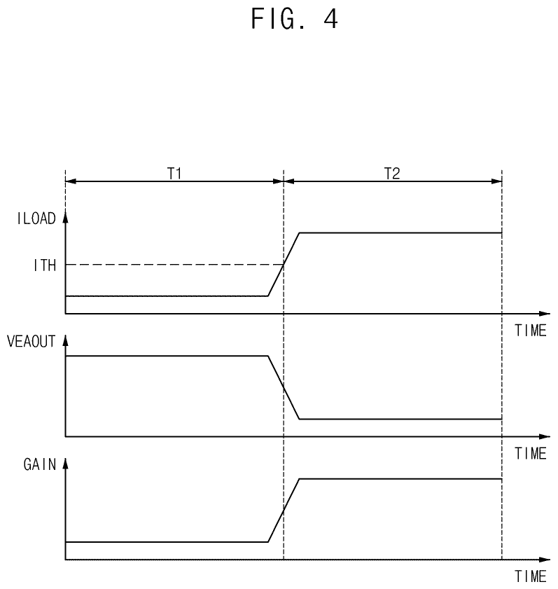

Referring to FIG. 4, an operation of the linear regulator 10a during a first time interval T1 and a second time interval T2 is illustrated.

The first time interval T1 may represent the operation illustrated in FIG. 3A, e.g., the operation under the light load condition where the amount of the load current ILOAD is relatively small. For example, the amount of the load current ILOAD may be less than a reference value ITH. During the first time interval T1, the first voltage VEAOUT may increase to have a relatively high voltage level, and the loop gain may decrease to have a relatively small value. Although not illustrated in detail, when the voltage level of the first voltage VEAOUT increases, the voltage level of the compensation voltage VC may decrease.

The second time interval T2 may represent the operation illustrated in FIG. 3B, e.g., the operation under the heavy load condition where the amount of the load current ILOAD is relatively large. For example, the amount of the load current ILOAD may be greater than or equal to the reference value ITH. During the second time interval T2, the first voltage VEAOUT may decrease to have a relatively low voltage level, and the loop gain may increase to have a relatively large value. Although not illustrated in detail, when the voltage level of the first voltage VEAOUT decreases, the voltage level of the compensation voltage VC may increase.

In the linear regulator 10a according to example embodiments, the gain bandwidth may decrease and a stable margin for the loop stability may be obtained under the light load condition, and the loop gain and the gain bandwidth may increase and the transient response may be improved under the heavy load condition.

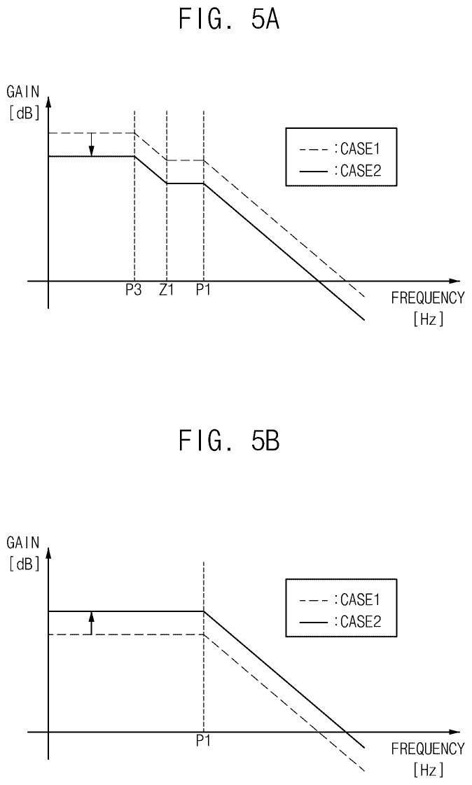

Referring to FIGS. 5A and 5B, performance of a conventional linear regulator that does not include the adaptive gain control circuit 200a is illustrated, and performance of the linear regulator 10a according to example embodiments that includes the adaptive gain control circuit 200a is illustrated. In FIGS. 5A and 5B, “CASE1” represents the conventional linear regulator, “CASE2” represents the linear regulator 10a according to example embodiments, and positions of poles P1 and P3 and zero Z1 are illustrated in the frequency domain.

As illustrated in FIG. 5A, under the light load condition where the amount of the load current ILOAD is relatively small, the loop gain may decrease in CASE2 which represents the linear regulator 10a according to example embodiments, as compared with CASE1 which is the conventional linear regulator.

As illustrated in FIG. 5B, under the heavy load condition where the amount of the load current ILOAD is relatively large, the loop gain may increase in CASE2, which represents the linear regulator 10a according to example embodiments, as compared with CASE1 which is the conventional linear regulator.

In addition, the pole P1 generated by the adaptive gain control circuit 200a may be located at a sufficiently high frequency, because a gate capacitance of the fifth transistor MN4 is sufficiently small and an impedance due to a diode connection structure of each of the third transistor MN1 and the fourth transistor MN2 is sufficiently small. Therefore, the positions of the poles and zeros within the gain bandwidth may not be affected (e.g., the positions of the poles and zeros may be maintained without any change) when controlling the loop gain. In addition, the gain bandwidth may be controlled by adjusting the loop gain, and thus the loop stability and the transient response may be efficiently controlled.

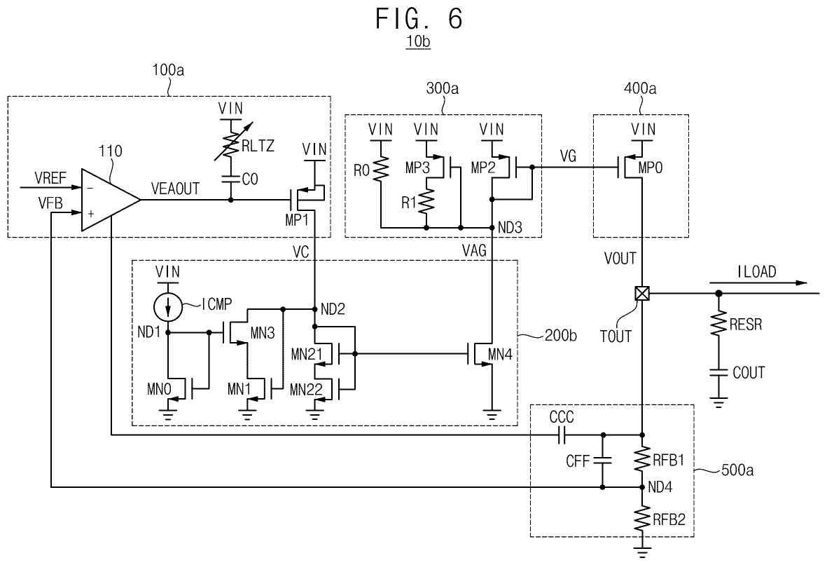

FIG. 6 is a circuit diagram illustrating a linear regulator according to example embodiments. The descriptions repeated with or overlapping with descriptions of FIG. 2 will be omitted in the interest of brevity.

Referring to FIG. 6, a linear regulator 10b may include a compensation circuit 100a, an adaptive gain control circuit 200b, a buffer circuit 300a, a driver circuit 400a, a feedback circuit 500a and the output terminal TOUT.

The linear regulator 10b of FIG. 6 may be substantially the same as the linear regulator 10a of FIG. 2, except that a configuration of the adaptive gain control circuit 200b in FIG. 6 is partially changed.

The adaptive gain control circuit 200b may include a current source ICMP, a first transistor MN0, a second transistor MN3, a third transistor MN1, a fourth-first transistor MN21, a fourth-second transistor MN22 and a fifth transistor MN4. The current source ICMP, the first transistor MN0, the second transistor MN3, the third transistor MN1 and the fifth transistor MN4 may be substantially the same as those described with reference to FIG. 2.

The fourth-first transistor MN21 and the fourth-second transistor MN22 may be connected in series between the second node ND2 and the ground voltage, and a gate electrode of each of the fourth-first transistor MN21 and the fourth-second transistor MN22 may be connected to the second node ND2. In other words, the fourth-first transistor MN21 may include a first electrode connected to the second node ND2, a second electrode connected to the fourth-second transistor MN22, and a gate electrode connected to the second node ND2, and the fourth-second transistor MN22 may include a first electrode connected to the fourth-first transistor MN21, a second electrode connected to the ground voltage, and a gate electrode connected to the second node ND2.

In some example embodiments, each of the fourth-first transistor MN21 and the fourth-second transistor MN22 may be an NMOS transistor.

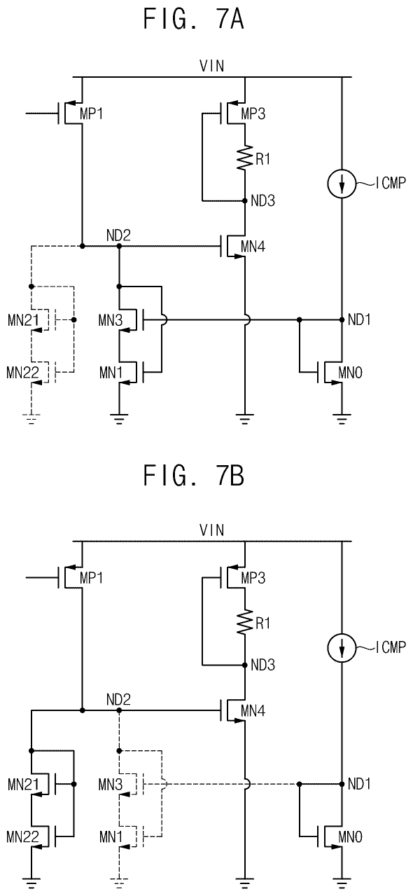

FIGS. 7A and 7B are diagrams for describing an operation of a linear regulator of FIG. 6 according to example embodiments. The descriptions repeated with or overlapping with descriptions of FIGS. 3A and 3B will be omitted in the interest of brevity.

Referring to FIGS. 7A and 7B, equivalent circuits of the current source ICMP, the transistors MP1, MP3, MN0, MN1, MN21, MN22, MN3 and MN4 and the resistor R1 included in the linear regulator 10b of FIG. 6 are illustrated. FIG. 7A illustrates an operation under the light load condition where the amount of the load current ILOAD is relatively small. FIG. 7B illustrates an operation under the heavy load condition where the amount of the load current ILOAD is relatively large.

As illustrated in FIG. 7A, when the amount of the load current ILOAD is relatively small, the second and third transistors MN3 and MN1 may be activated, the fourth-first and fourth-second transistors MN21 and MN22 may be relatively small activated or may be deactivated, and the loop gain may be determined based on the gain of the second transistor MN3 and the gain of the third transistor MN1. Under the light load condition in FIG. 7A, the voltage level of each of the feedback voltage VFB and the first voltage VEAOUT may increase, the voltage level of the compensation voltage VC may decrease, and the voltage level of each of the first drive voltage VAG and the second driving voltage VG may increase.

As illustrated in FIG. 7B, when the amount of the load current ILOAD is relatively large, the fourth-first and fourth-second transistors MN21 and MN22 may be activated, the second and third transistors MN3 and MN1 may be relatively small activated or may be deactivated, and the loop gain may be determined based on a gain of the fourth-first transistor MN21 and a gain of the fourth-second transistor MN22. In this example, the fourth-first and fourth-second transistors MN21 and MN22 may be referred to as a second loop gain determination circuit, a loop gain determination circuit for the heavy load, etc. Under the heavy load condition in FIG. 7B, the voltage level of each of the feedback voltage VFB and the first voltage VEAOUT may decrease, the voltage level of the compensation voltage VC may increase, and the voltage level of each of the first drive voltage VAG and the second driving voltage VG may decrease.

In some example embodiments, the gain of the fourth-first transistor MN21 and the gain of the fourth-second transistor MN22 in FIGS. 7A and 7B may be greater than the gain of the fourth transistor MN2 in FIGS. 3A and 3B. For example, each of the gain of the fourth-first transistor MN21 and the gain of the fourth-second transistor MN22 may be about 4. In this example, under the heavy load condition in FIG. 7B, it may be approximated as GA_{heavy}=gmp1*Rout*(128/2), as with that described with reference to FIGS. 3A and 3B.

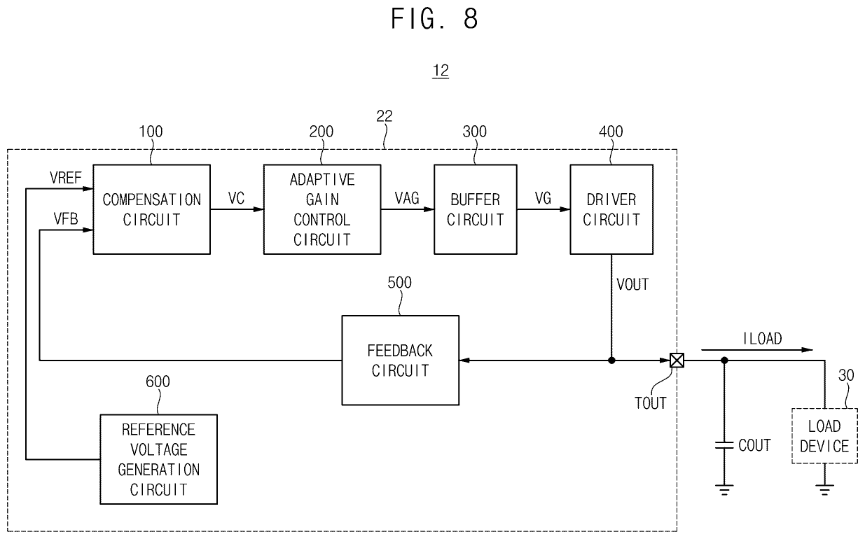

FIG. 8 is a block diagram illustrating a linear regulator according to example embodiments. The descriptions repeated with or overlapping with descriptions of FIG. 1 will be omitted in the interest of brevity.

Referring to FIG. 8, a linear regulator 12 includes a compensation circuit 100, an adaptive gain control circuit 200, a buffer circuit 300, a driver circuit 400, a feedback circuit 500 and an output terminal TOUT, and may further include a reference voltage generation circuit 600.

The linear regulator 12 of FIG. 8 may be substantially the same as the linear regulator 10 of FIG. 1, except that the linear regulator 12 further includes the reference voltage generation circuit 600.

The reference voltage generation circuit 600 may generate the reference voltage VREF, and may provide the reference voltage VREF to the compensation circuit 100. For example, although not illustrated in detail, the reference voltage VREF may be generated based on the input voltage VIN.

In some example embodiments, components (e.g., the compensation circuit 100, the adaptive gain control circuit 200, the buffer circuit 300, the driver circuit 400, the feedback circuit 500, the output terminal TOUT and the reference voltage generation circuit 600) included in the linear regulator 12 may be included in a semiconductor chip 22, and may be electrically connected to the output capacitor COUT and the load device 30 that are located outside the semiconductor chip 22.

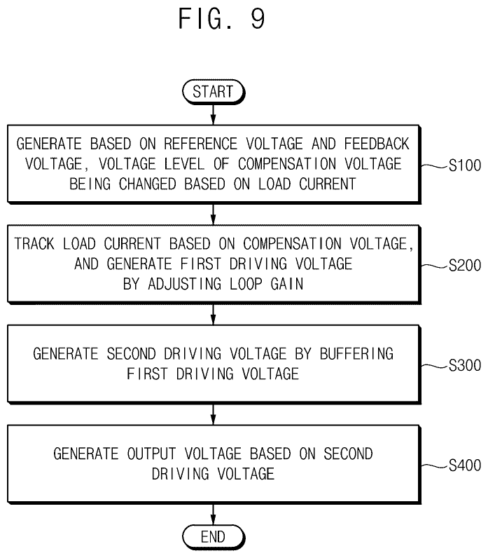

FIG. 9 is a flowchart illustrating a method of generating an output voltage according to example embodiments.

Referring to FIG. 9, a method of generating an output voltage according to example embodiments may be performed by the linear regulator according to example embodiments described with reference to FIGS. 1, 2, 3A, 3B, 4, 5A, 5B, 6, 7A, 7B and 8.

In the method of generating the output voltage according to example embodiments, the compensation voltage VC whose voltage level is changed based on the load current ILOAD is generated based on and the reference voltage VREF and the feedback voltage VFB generated by feeding back the output voltage VOUT (operation S100). For example, S100 may be performed by the compensation circuit 100.

The load current ILOAD is tracked based on the compensation voltage VC, and the first driving voltage VAG is generated by adjusting the loop gain (operation S200). For example, S200 may be performed by the adaptive gain control circuit 200 that performs the self-gain control function.

The second driving voltage VG is generated by buffering the first driving voltage VAG (operation S300). For example, S300 may be performed by the buffer circuit 300.

The output voltage VOUT is generated based on the second driving voltage VG (operation S400). For example, S400 may be performed by the driver circuit 400.

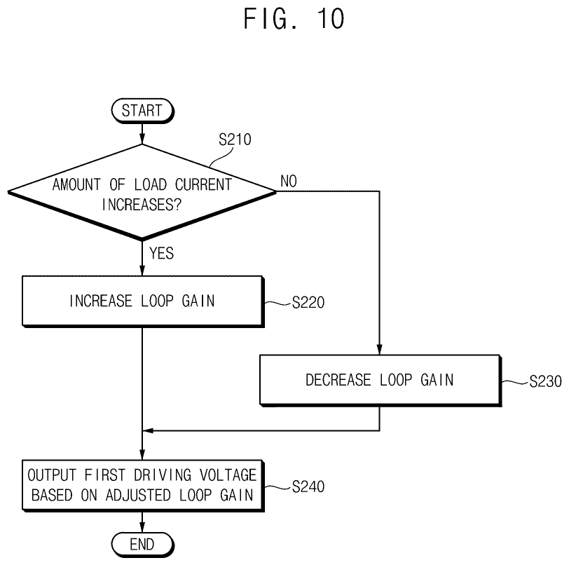

FIG. 10 is a flowchart illustrating an example of generating a first driving voltage in FIG. 9 according to example embodiments.

Referring to FIGS. 9 and 10, when generating the first driving voltage VAG (operation S200), it may be determined whether the amount of the load current ILOAD increases or decreases based on the compensation voltage VC (operation S210).

When it is determined that the amount of the load current ILOAD increases (operation S210: YES), e.g., when the amount of the load current ILOAD is greater than or equal to the reference value ITH, the loop gain may increase (operation S220). For example, when the voltage level of the first voltage VEAOUT decreases and when the voltage level of the compensation voltage VC increases, the loop gain may increase.

When it is determined that the amount of the load current ILOAD decreases (operation S210: NO), e.g., when the amount of the load current ILOAD is less than the reference value ITH, the loop gain may decrease (operation S230). For example, when the voltage level of the first voltage VEAOUT increases and when the voltage level of the compensation voltage VC decreases, the loop gain may decrease.

The first driving voltage VAG may be output based on the loop gain adjusted by S220 or S230 (operation S240).

As will be appreciated by those skilled in the art, the example embodiments may be embodied as a system, method, computer program product, and/or a computer program product embodied in one or more computer readable medium(s) having computer readable program code embodied thereon. The computer readable program code may be provided to a processor of a general purpose computer, special purpose computer, or other programmable data processing apparatus. The computer readable medium may be a computer readable signal medium or a computer readable storage medium. The computer readable storage medium may be any tangible medium that can contain or store a program for use by or in connection with an instruction execution system, apparatus, or device. For example, the computer readable medium may be a non-transitory computer readable medium.

FIG. 11 is a block diagram illustrating an electronic device including a linear regulator according to example embodiments.

Referring to FIG. 11, an electronic device 800 includes a first semiconductor chip 810, an output capacitor COUT and a second semiconductor chip 820. The electronic device 800 may further include a controller 830 and a PCB 840.

The first semiconductor chip 810 includes a linear regulator that provides an output voltage VOUT through an output terminal. For example, the linear regulator may receive an input voltage VIN from a battery (not illustrated), and may generate the output voltage VOUT based on the input voltage VIN.

For example, the linear regulator may be the linear regulator according to example embodiments described with reference to FIGS. 1, 2, 3A, 3B, 4, 5A, 5B, 6, 7A, 7B, and 8, and the first semiconductor chip 810 may correspond to the semiconductor chip 20 in FIG. 1. For example, the linear regulator may include the adaptive gain control circuit that adaptively and/or dynamically adjusts the loop gain depending on the amount of the load current. In the heavy load condition, the loop gain of the linear regulator may increase to improve the gain bandwidth and the transient response. In the light load condition, the loop gain of the linear regulator may decrease to ensure the loop stability. Accordingly, a relatively high loop stability and a relatively high transient response may be achieved over the entire range of the load current without changing the position of the dominant pole, and the performance of the linear regulator may be improved or enhanced.

The output capacitor COUT is connected between the output terminal and a ground voltage. The second semiconductor chip 820 receives the output voltage VOUT as a power supply voltage. For example, the output capacitor COUT and the second semiconductor chip 820 may correspond to the output capacitor COUT and the load device 30 in FIG. 1, respectively. For example, the second semiconductor chip 820 may be a device that receives the output voltage VOUT as the power supply voltage and consumes the load current, and may be, for example, one of a memory storing data and a central processing unit (CPU) performing computational operations.

The controller 830 may control operations of the first semiconductor chip 810 and/or the second semiconductor chip 820. The first semiconductor chip 810, the output capacitor COUT, the second semiconductor chip 820 and the controller 830 may be mounted on the PCB 840.

In some example embodiments, the first semiconductor chip 810 may further include a DC-DC (direct current) converter (e.g., a buck converter) having different type from the linear regulator. For example, the buck converter may operate in either an adaptive on-time (AOT) scheme or a constant on-time (COT) scheme depending on an operation mode of the second semiconductor chip 820, which is a load device, (e.g., depending on the load current).

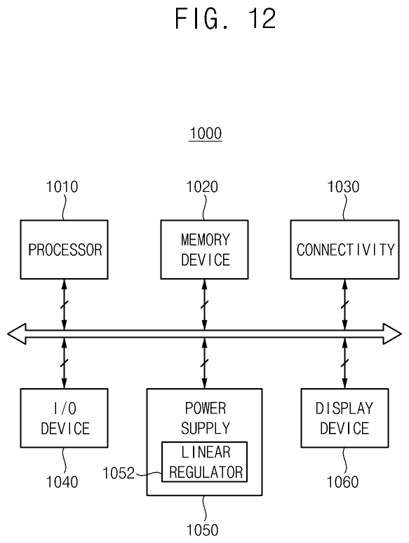

FIG. 12 is a block diagram illustrating an electronic system according to example embodiments.

Referring to FIG. 12, an electronic system 1000 may include a processor 1010, a memory device 1020, a connectivity 1030, an input/output (I/O) device 1040, a power supply 1050 and a display device 1060. The electronic system 1000 may further include a plurality of ports for communicating a video card, a sound card, a memory card, a universal serial bus (USB) device, other electronic devices, etc.

The processor 1010 may control operations of the electronic system 1000. The processor 1010 may execute an operating system (OS) and at least one application to provide an internet browser, games, videos, or the like. The memory device 1020 may store data for the operations of the electronic system 1000. The connectivity 1030 may communicate with an external device and/or system. The I/O device 1040 may include an input device such as a keyboard, a keypad, a mouse, a touchpad, a touch-screen, a remote controller, etc., and an output device such as a printer, a speaker, etc. The display device 1060 may include a display panel and a display driver integrated circuit, and may display images.

The power supply 1050 may provide a power for operations of the electronic system 1000. The power supply 1050 may include a linear regulator 1052. For example, the linear regulator 1052 may be the linear regulator according to example embodiments described with reference to FIGS. 1, 2, 3A, 3B, 4, 5A, 5B, 6, 7A, 7B and 8. For example, the linear regulator 1052 may include the adaptive gain control circuit that adaptively and/or dynamically adjusts the loop gain depending on the amount of the load current. In the heavy load condition, the loop gain of the linear regulator 1052 may increase to improve the gain bandwidth and the transient response. In the light load condition, the loop gain of the linear regulator 1052 may decrease to ensure the loop stability. Accordingly, a relatively high loop stability and a relatively high transient response may be achieved over the entire range of the load current without changing the position of the dominant pole, and the performance of the linear regulator 1052 may be improved or enhanced.

The example embodiments may be applied to various electronic devices and systems that include the linear regulators. For example, the example embodiments may be applied to systems such as a personal computer (PC), a server computer, a data center, a workstation, a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, a drone, an automotive, etc.

The foregoing is illustrative of example embodiments and is not to be construed as limiting thereof. Although some example embodiments have been described, those skilled in the art will readily appreciate that many modifications are possible in the example embodiments without materially departing from the novel teachings and advantages of the example embodiments. Accordingly, all such modifications are intended to be included within the scope of the example embodiments as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the present invention as set forth in the appended claims.

What is claimed is:

1. A linear regulator comprising:
a compensation circuit configured to generate a compensation voltage based on a reference voltage and a feedback voltage, a voltage level of the compensation voltage being changed based on a load current that is generated by an output voltage and flows through an output terminal;
an adaptive gain control circuit configured to track the load current based on the compensation voltage, and to generate a first driving voltage by adjusting a loop gain based on an amount of the load current;
a buffer circuit configured to generate a second driving voltage by buffering the first driving voltage;
a driver circuit connected to the output terminal, and configured to generate the output voltage based on the second driving voltage; and
a feedback circuit connected to the output terminal, and configured to generate the feedback voltage based on the output voltage.

2. The linear regulator of claim 1, wherein, when the amount of the load current increases, the loop gain increases, and
wherein, when the amount of the load current decreases, the loop gain decreases.

3. The linear regulator of claim 1, wherein the adaptive gain control circuit includes:
a current source connected between an input voltage and a first node;
a first transistor connected between the first node and a ground voltage, and having a gate electrode connected to the first node;
a second transistor connected to a second node configured to receive the compensation voltage, and having a gate electrode connected to the first node;
a third transistor connected between the second transistor and the ground voltage, and having a gate electrode connected to the second node;
a fourth transistor connected between the second node and the ground voltage, and having a gate electrode connected to the second node; and
a fifth transistor connected between the ground voltage and a third node configured to provide the first driving voltage, and having a gate electrode connected to the second node.

4. The linear regulator of claim 3, wherein, when the amount of the load current is less than a reference value, the loop gain is determined based on a gain of the second transistor and a gain of the third transistor, and
wherein, when the amount of the load current is greater than or equal to the reference value, the loop gain is determined based on a gain of the fourth transistor.

5. The linear regulator of claim 4, wherein the gain of the fourth transistor is smaller than the gain of the second transistor and the gain of the third transistor.

6. The linear regulator of claim 3, wherein each of the first transistor, the second transistor, the third transistor, the fourth transistor and the fifth transistor are an n-type metal oxide semiconductor (NMOS) transistor.

7. The linear regulator of claim 3, wherein the compensation circuit includes:
a comparator configured to generate a first voltage based on the reference voltage and the feedback voltage;
a first resistor and a first capacitor connected in series between the input voltage and the output terminal of the comparator; and
a sixth transistor connected between the input voltage and the second node, and having a gate electrode receiving the first voltage.

8. The linear regulator of claim 7, wherein, when the amount of the load current increases, a voltage level of the first voltage decreases, and
wherein, when the amount of the load current decreases, the voltage level of the first voltage increases.

9. The linear regulator of claim 7, wherein the sixth transistor is a p-type metal oxide semiconductor (PMOS) transistor.

10. The linear regulator of claim 3, wherein the buffer circuit includes:
a second resistor connected between the input voltage and the third node;
a seventh transistor connected to the input voltage, and having a gate electrode connected to the third node;
a third resistor connected between the seventh transistor and the third node; and
an eighth transistor connected between the input voltage and the third node, and having a gate electrode connected to the third node.

11. The linear regulator of claim 10, wherein the driver circuit includes:
a ninth transistor connected between the input voltage and the output terminal, and having a gate electrode connected to the third node.

12. The linear regulator of claim 11, wherein each of the seventh transistor, the eighth transistor and the ninth transistor is a PMOS transistor.

13. The linear regulator of claim 3, wherein the feedback circuit includes:
a first feedback resistor connected between the output terminal and a fourth node configured to provide the feedback voltage; and
a second feedback resistor connected between the fourth node and the ground voltage.

14. The linear regulator of claim 1, wherein the adaptive gain control circuit includes:
a current source connected to a first node;
a first transistor connected between the first node and a ground voltage, and having a gate electrode connected to the first node;
a second transistor connected to a second node configured to receive the compensation voltage, and having a gate electrode connected to the first node;
a third transistor connected between the second transistor and the ground voltage, and having a gate electrode connected to the second node;
a fourth transistor and a fifth transistor connected in series between the second node and the ground voltage, each of the fourth transistor and the fifth transistor having a gate electrode connected to the second node; and
a sixth transistor connected between the ground voltage and a third node configured to provide the first driving voltage, and having a gate electrode connected to the second node.

15. The linear regulator of claim 14, wherein, when the amount of the load current is less than a reference value, the loop gain is determined based on a gain of the second transistor and a gain of the third transistor, and
wherein, when the amount of the load current is greater than or equal to the reference value, the loop gain is determined based on a gain of the fourth transistor and a gain of the fifth transistor.

16. The linear regulator of claim 1, further comprising:
a reference voltage generation circuit configured to generate the reference voltage.

17. The linear regulator of claim 1, wherein the linear regulator is connected to an output capacitor through the output terminal.

18. The linear regulator of claim 17, wherein the compensation circuit, the adaptive gain control circuit, the buffer circuit, the driver circuit and the feedback circuit are included in a semiconductor chip, and
wherein the output capacitor is located outside the semiconductor chip.

19. An electronic device comprising:
a first semiconductor chip including a linear regulator configured to provide an output voltage through an output terminal;
an output capacitor connected between the output terminal and a ground voltage; and
a second semiconductor chip configured to receive the output voltage as a power supply voltage,
wherein the linear regulator comprises:
a compensation circuit configured to generate a compensation voltage based on a reference voltage and a feedback voltage, a voltage level of the compensation voltage being changed based on a load current that is generated by the output voltage and flows through the output terminal;
an adaptive gain control circuit configured to track the load current based on the compensation voltage, and to generate a first driving voltage by adjusting a loop gain based on an amount of the load current;
a buffer circuit configured to generate a second driving voltage by buffering the first driving voltage;
a driver circuit connected to the output terminal, and configured to generate the output voltage based on the second driving voltage; and
a feedback circuit connected to the output terminal, and configured to generate the feedback voltage based on the output voltage.

20. A linear regulator comprising:
a compensation circuit configured to generate a compensation voltage based on a reference voltage and a feedback voltage, a voltage level of the compensation voltage being changed based on a load current that is generated by an output voltage and flows through an output terminal;
an adaptive gain control circuit configured to track the load current based on the compensation voltage, and to generate a first driving voltage by adjusting a loop gain based on an amount of the load current;
a buffer circuit configured to generate a second driving voltage by buffering the first driving voltage;
a driver circuit connected to the output terminal, and configured to generate the output voltage based on the second driving voltage; and
a feedback circuit connected to the output terminal, and configured to generate the feedback voltage based on the output voltage,
wherein the adaptive gain control circuit includes:
a current source connected between an input voltage and a first node;
a first transistor connected between the first node and a ground voltage, and having a gate electrode connected to the first node;
a second transistor connected to a second node configured to receive the compensation voltage, and having a gate electrode connected to the first node;
a third transistor connected between the second transistor and the ground voltage, and having a gate electrode connected to the second node;
a fourth transistor connected between the second node and the ground voltage, and having a gate electrode connected to the second node; and
a fifth transistor connected between the ground voltage and a third node configured to provide the first driving voltage, and having a gate electrode connected to the second node,
wherein, when the amount of the load current increases, the loop gain increases and the loop gain is determined based on a gain of the fourth transistor, and
wherein, when the amount of the load current decreases, the loop gain decreases and the loop gain is determined based on a gain of the second transistor and a gain of the third transistor.
